(19) United States
(12) Patent Application Publication
(10) Pub. No.: US 2025/0371868 A1
(43) Pub. Date: Dec. 4, 2025

(54) OBJECT AND EVENT CLASSIFICATION BASED ON STATIC VIDEO FRAMES

(71) Applicant: Roku, Inc., San Jose, CA (US)

(72) Inventors: Soren Riise, Templeton, CA (US); Sunil Ramesh, Saratoga, CA (US); Patrick Brouillette, Tempe, AZ (US); Gregory Garner, Key Colony Beach, FL (US); Karina Levitian, Austin, TX (US)

(21) Appl. No.: 18/676,199

(22) Filed: May 28, 2024

(51) Int. Cl. G06V 20/40; G06V 10/60; G06V 10/74; G06V 10/75; G06V 20/52

(52) U.S. Cl. CPC G06V 20/41; G06V 10/60; G06V 10/759; G06V 10/761; G06V 20/44; G06V 20/46; G06V 20/52

(57) ABSTRACT

Disclosed herein are system, apparatus, article of manufacture, method and/or computer program product embodiments, and/or combinations and sub-combinations thereof, for performing event or object classification. An example process can include receiving a first trigger corresponding to a first motion event within a field of view of a first image sensor; selecting a first video frame from a sequence of video frames captured by the first image sensor, wherein the first video frame is captured prior to the first trigger; selecting a second video frame from the sequence of video frames, wherein the second video frame is captured after the first trigger; determining at least one difference between the first video frame and the second video frame; determining, based on the at least one difference, at least one of an object classification and an event classification; and generating a notification that corresponds to the object classification or the event classification.

### BACKGROUND

### Field

This disclosure is generally directed to electronic devices such as camera sensors, and more particularly, to using static video frames to classify objects and/or to classify events.

### Summary

Provided herein are system, apparatus, article of manufacture, method and/or computer program product embodiments, and/or combinations and sub-combinations thereof, for classifying objects and/or classifying events.

In some aspects, a method is provided for classifying an object/event based on static frames from a video recording. The method can operate in an electronic device (e.g., camera), in one or more computing devices (e.g., servers, mobile devices, IoT devices, etc.) that are communicatively coupled to the electronic device, and/or in a combination thereof.

The method can operate by receiving a first trigger corresponding to a first motion event within a field of view of a first image sensor. In some cases, the method can further include selecting a first video frame from a sequence of video frames captured by the first image sensor, wherein the first video frame is captured prior to the first trigger. In some examples, the method can also include selecting a second video frame from the sequence of video frames captured by the first image sensor, wherein the second video frame is captured after the first trigger. In some aspects, the method can further include determining at least one difference between the first video frame and the second video frame. In some cases, the method can further include determining, based on the at least one difference, at least one of an object classification and an event classification. In some instances, the method can also include generating a notification that corresponds to the object classification or the event classification.

In some aspects, a system is provided for classifying an object/event based on static frames from a video recording. The system can include one or more memories and at least one processor coupled to at least one of the one or more memories and configured to receive a first trigger corresponding to a first motion event within a field of view of a first image sensor. The at least one processor of the system can be configured to select a first video frame from a sequence of video frames captured by the first image sensor, wherein the first video frame is captured prior to the first trigger. The at least one processor of the system can be configured to select a second video frame from the sequence of video frames captured by the first image sensor, wherein the second video frame is captured after the first trigger. The at least one processor of the system can be configured to determine at least one difference between the first video frame and the second video frame. The at least one processor of the system can be configured to determine, based on the at least one difference, at least one of an object classification and an event classification. The at least one processor of the system can be configured to generate a notification that corresponds to the object classification or the event classification.

In some aspects, a non-transitory computer-readable medium is provided for classifying an object/event based on static frames from a video recording. The non-transitory computer-readable medium can have instructions stored thereon that, when executed by at least one computing device, cause the at least one computing device to receive a first trigger corresponding to a first motion event within a field of view of a first image sensor. The instructions of the non-transitory computer-readable medium can, when executed by the at least one computing device, cause the at least one computing device to select a first video frame from a sequence of video frames captured by the first image sensor, wherein the first video frame is captured prior to the first trigger. The instructions of the non-transitory computer-readable medium can, when executed by the at least one computing device, cause the at least one computing device to select a second video frame from the sequence of video frames captured by the first image sensor, wherein the second video frame is captured after the first trigger. The instructions of the non-transitory computer-readable medium can, when executed by the at least one computing device, cause the at least one computing device to determine at least one difference between the first video frame and the second video frame. The instructions of the non-transitory computer-readable medium can, when executed by the at least one computing device, cause the at least one computing device to determine, based on the at least one difference, at least one of an object classification and an event classification. The instructions of the non-transitory computer-readable medium can, when executed by the at least one computing device, cause the at least one computing device to generate a notification that corresponds to the object classification or the event classification.

### BRIEF DESCRIPTION OF THE FIGURES

The accompanying drawings are incorporated herein and form a part of the specification.

FIG. 1 illustrates a block diagram of a multimedia environment, according to some aspects of the present disclosure.

FIG. 2 illustrates a block diagram of a streaming media device, according to some aspects of the present disclosure.

FIG. 3 illustrates a block diagram of an IoT environment, according to some aspects of the present disclosure;

FIG. 4A, FIG. 4B, FIG. 4C, and FIG. 4D illustrate an example of an environment that includes electronic devices that can be configured to perform event classification or object classification, according to some aspects of the present disclosure;

FIG. 5A, FIG. 5B, FIG. 5C, and FIG. 5D illustrate examples of video frames that can be used to perform event classification or object classification, according to some aspects of the present disclosure;

FIG. 6 is a diagram illustrating an example system for performing event classification and/or object classification, according to some aspects of the present disclosure;

FIG. 7 is a diagram illustrating a flowchart of an example method for performing event classification or object classification, according to some aspects of the present disclosure;

FIG. 8 is a diagram illustrating a flowchart of another example method for performing event classification or object classification, according to some aspects of the present disclosure;

FIG. 9 is a diagram illustrating a flowchart of another example method for performing event classification or object classification, according to some aspects of the present disclosure;

FIG. 10 is a diagram illustrating a flowchart of another example method for performing event classification or object classification, according to some aspects of the present disclosure;

FIG. 11 is a diagram illustrating an example of a neural network architecture, according to some examples of the present disclosure; and

FIG. 12 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Security systems can include strategically placed cameras both inside and outside the premises. These cameras have video recording capabilities to monitor and record activities in and around an area such as a residence or a building. Users can access and review the recorded footage (e.g., video frames) through a user interface provided by the security system to view specific timeframes or to identify certain objects or events.

In some cases, it may be desirable to have image sensors that are capable of processing video data in real-time in order to make detections and provide alerts or notifications to a user. For instance, a user may wish to configure an image sensor to provide notifications that are based on one or more events (e.g., package delivery, ingress, egress, etc.). In another example, a user may wish to receive notifications based on the detection of certain objects (e.g., object appears and/or object is removed). For instance, an alert can be generated if an object such as a package is detected on the front porch. In another example, an alert can be generated when an object is removed (e.g., courier service picks up a parcel for shipping or a burglar steals a garden gnome). In further examples, image sensors may be configured to detect appearance, disappearance, and/or movement of any object (e.g., including unclassified objects), and an alert can be generated based on such detection(s).

Provided herein are system, apparatus, device, method and/or computer program product embodiments, and/or combinations and sub-combinations thereof, for performing event classification and/or object classification based on static video frames. In some aspects, a triggering event (e.g., motion event) can cause an image sensor to capture a video recording. In some cases, various video frames from the video recording can be selected and processed to perform event classification and/or object classification. For instance, a first video frame that is captured prior to the trigger can be compared to a second video frame that is captured after the trigger (e.g., after motion event has ended). In some aspects, the comparison between video frames can be used to determine one or more changes (e.g., temporal changes, spatial changes, etc.). In some cases, these changes can be used to perform object classification and/or event classification.

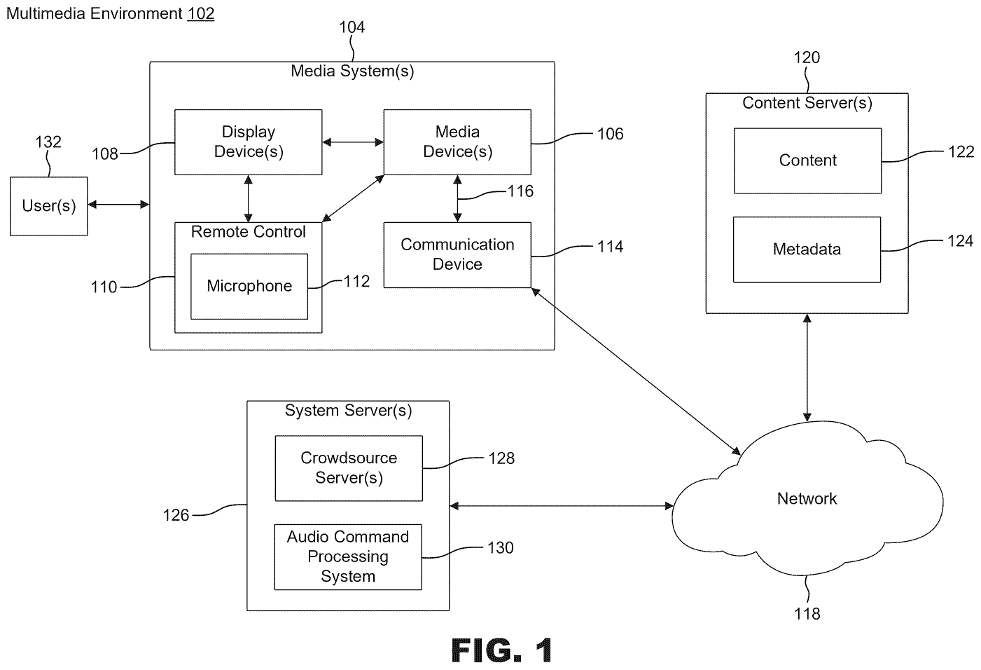

Various embodiments, examples, and aspects of this disclosure may be implemented using and/or may be part of a multimedia environment 102 shown in FIG. 1. It is noted, however, that multimedia environment 102 is provided solely for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

In some aspects, the multimedia environment 102 may be directed to multimedia surveillance and/or security systems. For example, multimedia environment 102 may include media system 104, which could represent a house, a building, an office, or any other location or space where it is desired to implement a surveillance and security system with one or more sensors (e.g., a camera, a microphone, etc.) to monitor the surrounding environment. User(s) 132 may operate with the media system 104 to consume the multimedia data (e.g., content) captured/collected by the sensors of the surveillance and security system.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, media device 106 can be a part of, integrated with, operatively coupled to, and/or connected to its respective display device 108.

In some examples, media device 106 may include one or more sensors implemented within a surveillance and security system such as a camera (or a security camera), a smart camera, a doorbell camera, an IoT camera, and/or any other type of image sensor that can be used to monitor and record the surroundings. The recording or live feed that is captured by such sensors can be sent to display device 108 such as a smartphone, computer, tablet, IoT device, etc.

Each media device 106 may be configured to communicate with network 118 via a communication device 114. The communication device 114 may include, for example, a cable modem or satellite TV transceiver. The media devices 106 may communicate with the communication device 114 over a link 116, wherein the link 116 may include wireless (such as WiFi) and/or wired connections. Alternatively, or in addition, media devices 106 may include one or more transceivers that can be configured to communicate directly with network 118 and/or with other media devices 106.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources). Although only one content server 120 is shown in FIG. 1, in practice, the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, targeted media content, software, recording or live feed from a surveillance and security system, and/or any other content or data objects in electronic form.

In some examples, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining to or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streaming of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

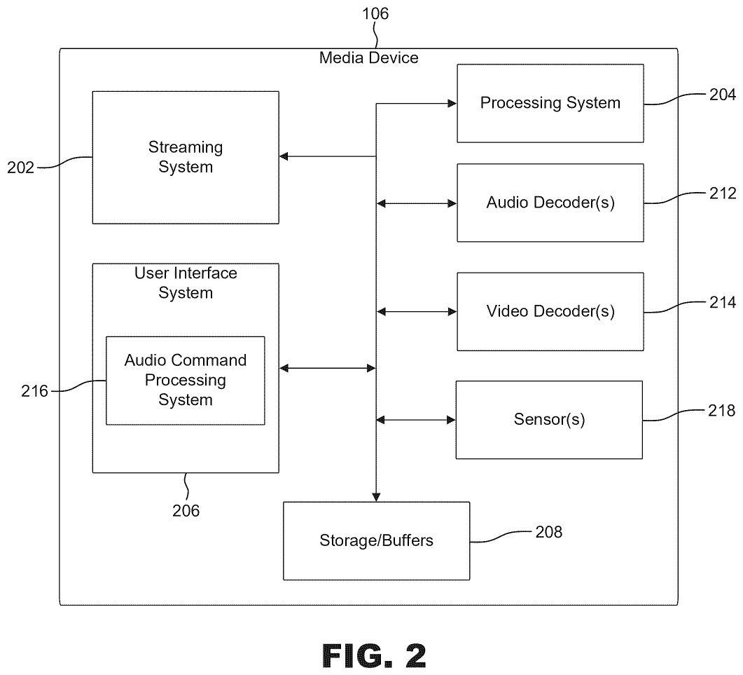

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

FIG. 2 illustrates a block diagram of an example media device 106, according to some embodiments. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. The media device 106 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

The media device 106 may also include one or more sensors 218. Examples of sensors 218 include but are not limited to image sensors, accelerometers, gyroscopes, inertial measurement units (IMUs), light sensors, positioning sensors (e.g., GNSS), any other type of sensor, and/or any combination thereof. In one illustrative example, sensors 218 may correspond to an image sensor of an IoT camera that can be configured to capture image data and/or video data as part of a security surveillance system. In some examples, media device 106 may also include one or more light sources (not illustrated). For instance, media device 106 can include an infrared (IR) light source, visible light source, laser source, or the like.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

### Examplary IoT Environment

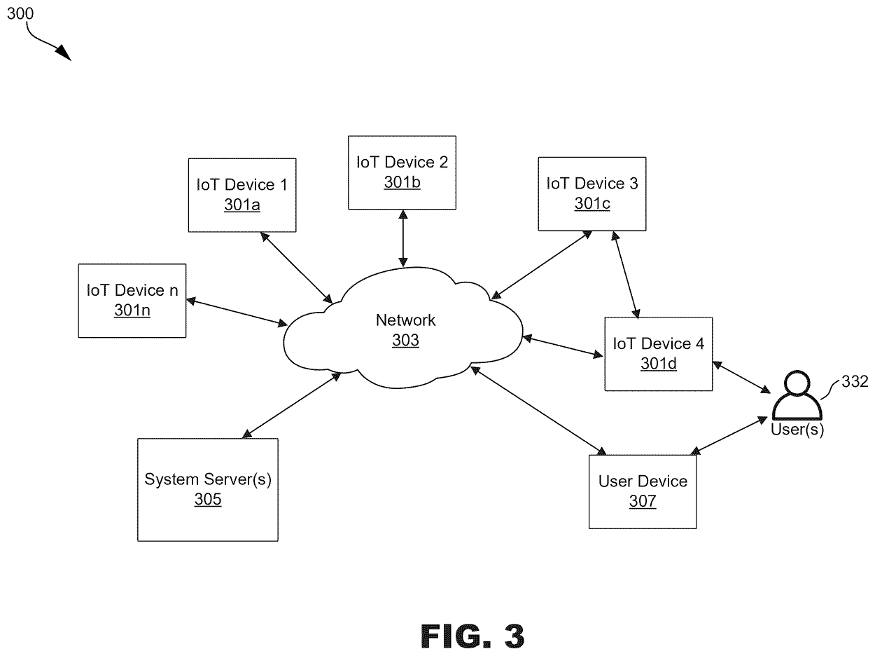

FIG. 3 illustrates a block diagram of an IoT environment 300, according to some aspects of the present technology. According to some examples, IoT environment 300 can be implemented with multimedia environment 102 of FIG. 1. For example, multimedia environment 102 of FIG. 1 can be part of IoT environment 300 or vice versa.

In some cases, IoT environment 300 can include a plurality of IoT devices 301a-301n (collectively referred to as IoT devices 301), network 303, one or more system servers 305, and user device 307. According to some aspects, IoT devices 301 can be connected to, and communicate with, each other using a mesh network. In this example, when an IoT device leaves the plurality of IoT devices 301 and/or an IoT device is added to the plurality of IoT devices 301, the mesh network can be updated accordingly. In one illustrative example, network 303 can correspond to a mesh network connecting the plurality of IoT devices 301.

In some cases, the mesh network can be part of network 303. For example, IoT devices 301 can be connected to each other (e.g., communicate with each other) using the mesh network. The mesh network can be implemented using a wireless local area network (WLAN) such as WiFi. However, the present technology is not limited to this example, and the mesh network can be implemented using other types of wireless and/or wired networks. In some examples, network 303 can include the mesh network and another wireless and/or wired networks. In some aspects, network 303 can include, without limitation, mesh, wired and/or wireless intranet, extranet, Internet, cellular, Bluetooth, infrared, and/or any other short range, long range, local, regional, global communications mechanism, means, approach, protocol and/or network, as well as any combination(s) thereof.

In some configurations, IoT environment 300 can include one or more system servers 305. System servers 305 may operate to support IoT devices 301. In some examples, system servers 305 may operate to support IoT devices 301 from a cloud. It is noted that the structural and functional aspects of system servers 305 may wholly or partially exist in the same or different systems. According to some examples, IoT devices 301 can communicate with system servers 305 through network 303. In some instances, system servers 305 can be associated with system servers 126 of FIG. 1. For example, the structural and functional aspects of system servers 305 may wholly or partially exist in the same or different ones of the system servers 126.

In some instances, system servers 305 can include one or more user accounts associated with IoT devices 301 and/or their associated network 303. In a non-limiting example, IoT devices 301 can include IoT devices associated with a physical property of user 332 on one network 303. In this example, IoT devices 301 and network 303 can be associated with the user account of user 332.

IoT environment 300 can also include one or more user devices 307. In some aspects, user device 307 can be any of a personal digital assistant (PDA), desktop workstation, laptop or notebook computer, netbook, tablet, smart phone, smart watch or other wearable appliance, to name a few non-limiting examples, or any combination thereof. In some examples, user 332 can control and/or configure one or more IoT devices 301 using user device 307. For example, IoT device 301 can use radio frequency (RF) signals (e.g., WLAN) to receive configuration and/or control information from user device 307.

IoT devices 301 can include any IoT device. As some non-limiting examples, IoT devices 301 can include smart appliances such as, but no limited to, smart TVs, smart refrigerators, smart washers, smart dryers, smart dishwashers, smart ovens and gas tops, smart microwaves, smart heating, ventilation, and air conditionings (HVACs), smart fans, smart blinds, or the like. As other non-limiting examples, IoT devices 301 can include smart home security systems, smart locks, smart fire alarms/systems, or the like. IoT devices 301 can include sensors used in homes, offices, factories, medical sensors, fitness sensors/trackers, or the like. It is noted that although some aspects of this disclosure are discussed with respect to some exemplary IoT devices, the present technology is not limited to these examples and can be applied to other IoT devices.

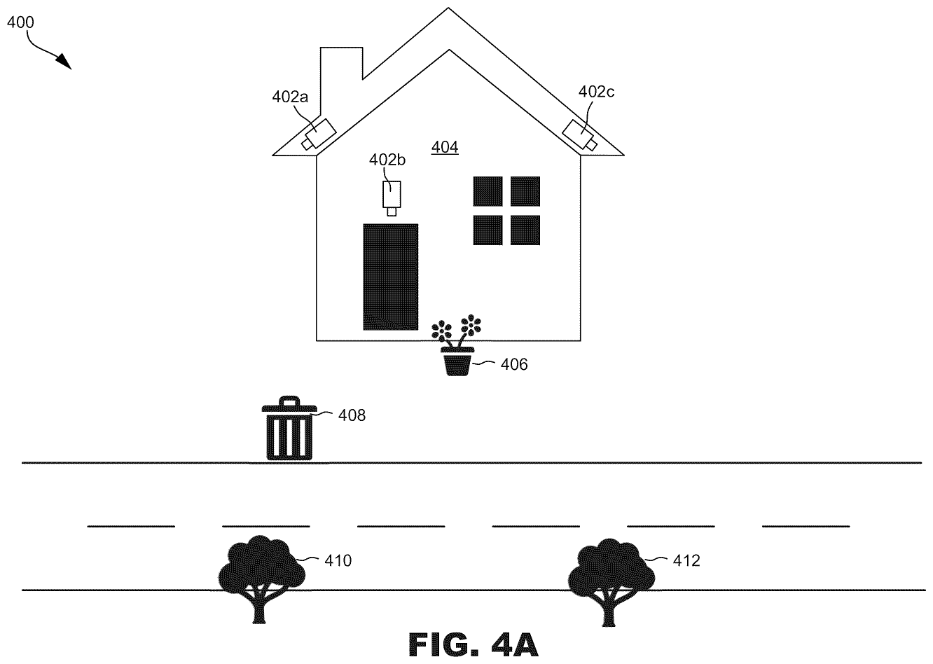

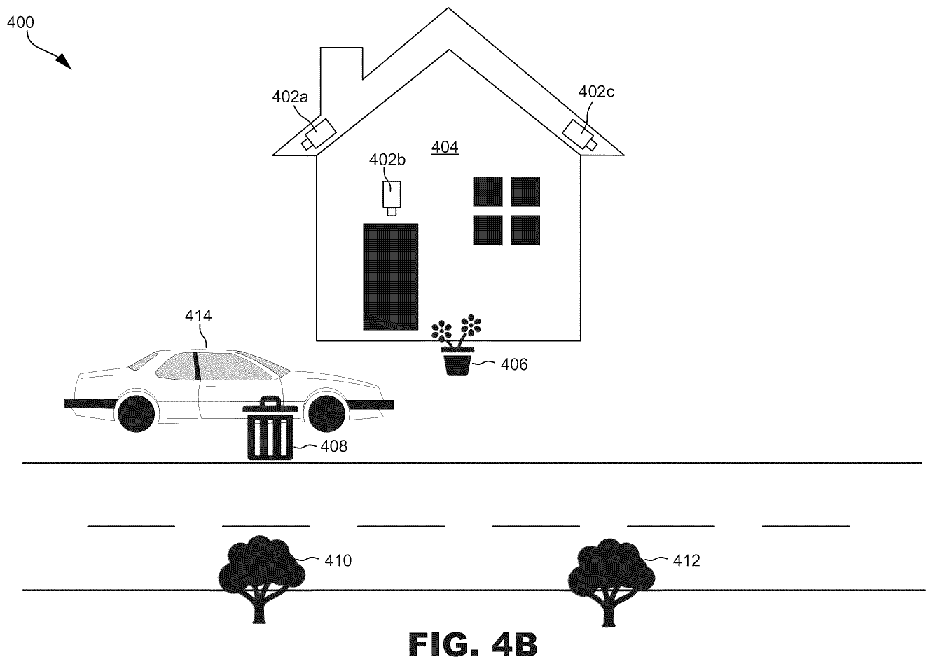

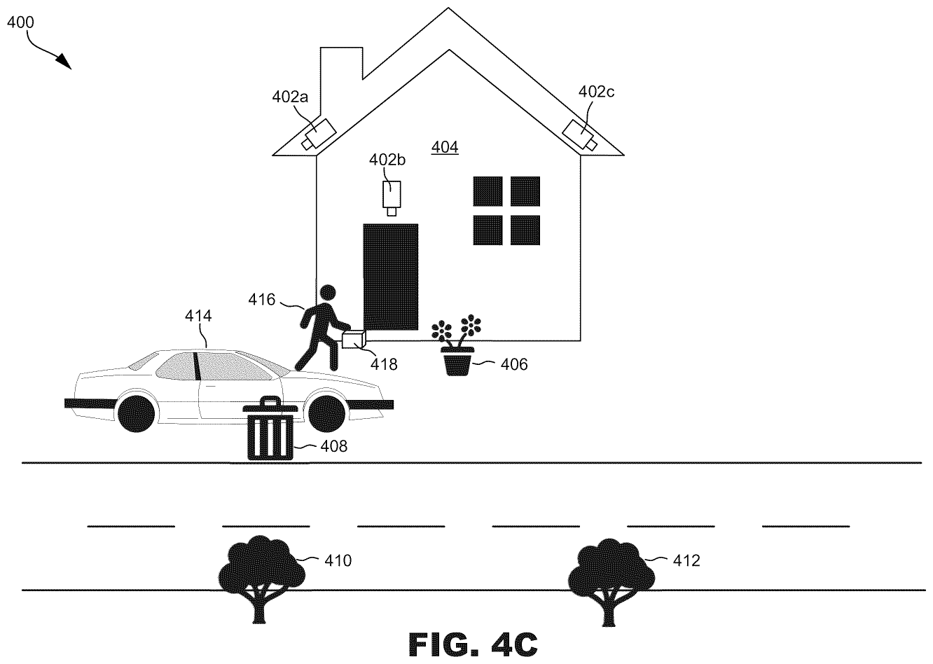

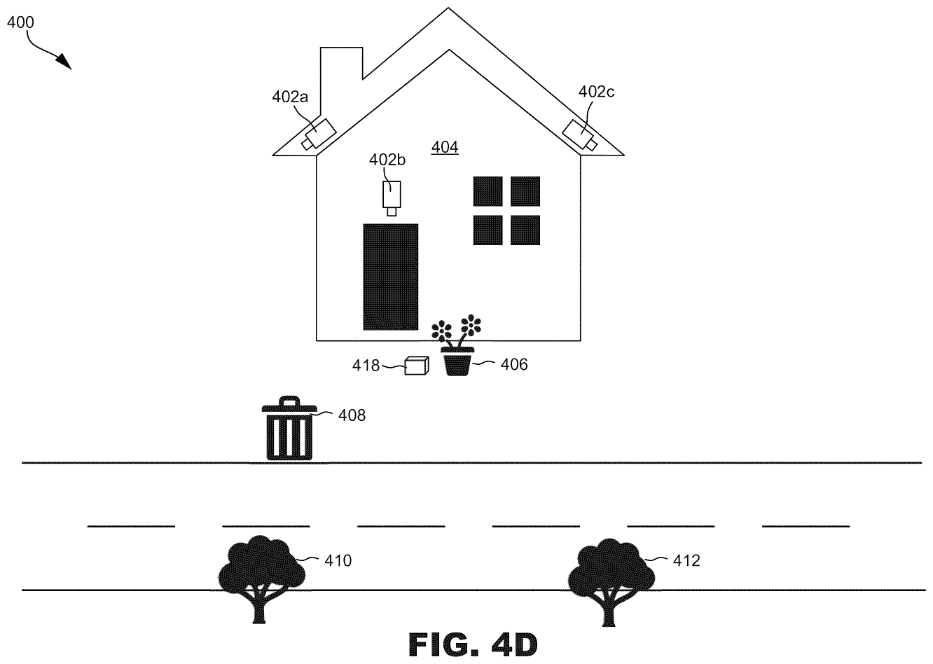

FIG. 4A illustrates an example of an environment 400 that includes electronic devices that can be configured to perform event classification and/or object classification. As illustrated, environment 400 includes camera 402a, camera 402b, and camera 402c (collectively referred to as “cameras 402”) that are coupled to house 404. In some examples, cameras 402 can correspond to one of IoT devices 301 that can be configured to communicate with one or more servers (e.g., system servers 305), user devices (e.g., user device 307), networks (e.g., network 303), other IoT devices (e.g., IoT devices 301), and/or any other electronic device. In some cases, cameras 402 can be part of a security or surveillance system.

In some aspects, cameras 402 can be configured to capture and record image data and/or video data from environment 400. In some cases, image data and/or video data that is recorded by cameras 402 can be stored locally and/or sent to one or more other electronic devices (e.g., user devices, servers, IoT devices, etc.). In some examples, cameras 402 can be configured to implement continuous recording (e.g., camera can record 1-minute video clips continuously or for a set time period). In further examples, cameras 402 can be configured to implement scheduled recording (e.g., camera can capture video during designated time(s)—daily, weekly, monthly, one-time occurrence, etc.). In further examples, cameras 402 can be configured to implement event recordings (e.g., based on a trigger such as motion or sound). In further examples, cameras 402 can be configured to implement time lapse recording (e.g., capture images at regular intervals).

In some examples, video recorded by cameras 402 can be used to perform object classification. That is, video frames captured by cameras 402 can be used (e.g., by cameras 402, a server, and/or any other electronic device) to identify and label objects within environment 400. For instance, as illustrated in FIG. 4A, video frames that are captured by cameras 402 can be used to identify and label garbage can 408, tree 410, and/or tree 412.

In some aspects, video recorded by cameras 402 can be used to perform event classification. That is, video frames captured by cameras 402 can be used (e.g., by cameras 402, a server, and/or any other electronic device) to classify (e.g., categorize, label, identify, etc.) an event or activity within environment 400. Examples of event classifications can include but are not limited to an ingress event (e.g., person arriving at premises); an egress event (e.g., person leaving premises); a delivery event (e.g., mail delivery, food delivery, package delivery); a pick-up event (e.g., package pick-up; garbage collection, etc.); a trespass event (e.g., unknown person or thing violating a protected zone); a service event (e.g., landscaping service, painting service, etc.); a weather event (e.g., rain, snow, fog, wind, etc.); an animal event (e.g., dog/cat, wildlife, etc.); an obstruction event (e.g., obstructed field of view caused by any object such as a spiderweb, overgrown foliage, etc.); an object shift event (e.g., change in position or pose of an object, which may include unclassified objects); an object appearance event (e.g., new object detected within scene, which can include unclassified objects); an object removal event (e.g., object removed from scene, which may include unclassified objects); any other type of event; and/or any combination thereof.

In some cases, object classification and/or event classification can be implemented by selecting and processing particular video frames from a video frame sequence. In some instances, a video frame sequence (e.g., video recording) may be captured in response to a trigger. For example, the video recording may be triggered by a motion sensor (e.g., passive infrared (PIR) sensor, ultrasonic sensor, microwave sensor, tomographic sensor, etc.). In some configurations, a motion sensor may be coupled to or embedded within cameras 402.

In some aspects, environment 400 as illustrated in FIG. 4A can correspond to a steady state environment (e.g., no motion triggers). In some cases, cameras 402 may capture video recordings of environment 400. For instance, cameras 402 may be configured to capture video continuously or at some time interval irrespective of a motion trigger. In some cases, cameras 402 can capture and store a pre-roll (e.g., video recording prior to trigger event) and/or a post-roll (e.g., video recording following a trigger event). In some instances, the timing of the video recordings can be adaptable. In some configurations, video recordings can be compressed (e.g., time compressed) such as when no trigger condition is detected. In some examples, one or more video frames from a recording can be deleted (e.g., sequential frames that are redundant-no new information-may be deleted).

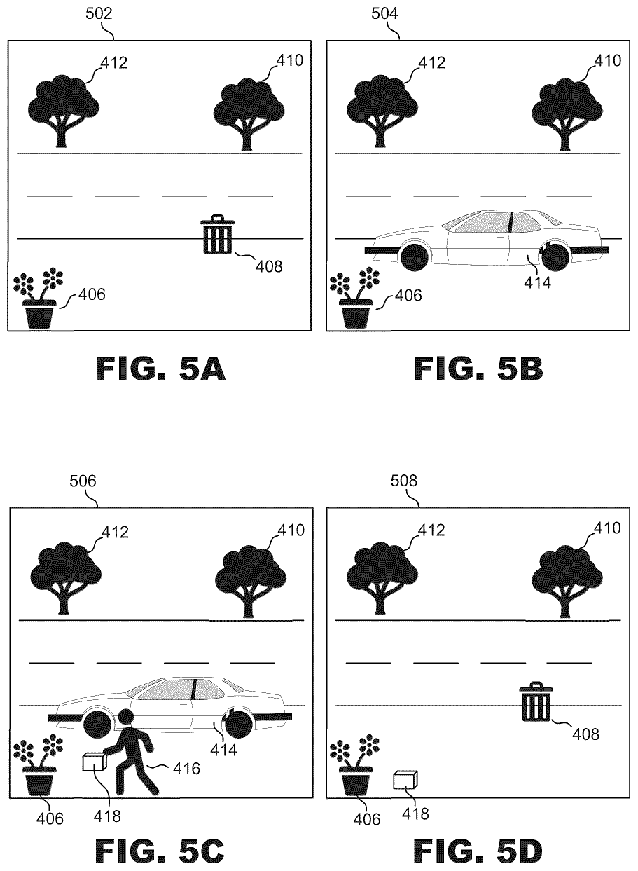

FIG. 5A illustrates an example of a video frame 502 that may be captured by one or more of cameras 402 from environment 400 as illustrated in FIG. 4A. Video frame 502 can include plant 406, garbage can 408, tree 410, and tree 412.

FIG. 4B illustrates an example of an environment 400 in which vehicle 414 is positioned in front of house 404. In some aspects, cameras 402 can capture a video recording of environment 400 in response to a motion trigger caused by vehicle 414. As illustrated, vehicle 414 may block or obfuscate visibility of garbage can 408.

FIG. 5B illustrates an example of a video frame 504 that may be captured by one or more of cameras 402 from environment 400 as illustrated in FIG. 4B. Video frame 504 can include plant 406, tree 410, tree 412, and vehicle 414.

FIG. 4C illustrates an example of an environment 400 in which a person 416 has exited vehicle 414 and is carrying a package 418 towards house 404. In some examples, cameras 402 can capture a video recording of environment 400 in response to a motion trigger caused by person 416. Alternatively, or in addition, cameras 402 may record movement of person 416 pursuant to a trigger caused by vehicle 414 (e.g., cameras 402 may be configured to continue recording for a set time period after receiving a trigger).

FIG. 5C illustrates an example of a video frame 506 that may be captured by one or more of cameras 402 from environment 400 as illustrated in FIG. 4C. Video frame 506 can include plant 406, tree 410, tree 412, vehicle 414, person 416, and package 418.

FIG. 4D illustrates an example of an environment 400 in which the delivery has been completed. That is, person 416 has driven away in vehicle 414, and package 418 is laying on the ground adjacent to plant 406. In some examples, cameras 402 can capture a video recording of environment 400 in response to a motion trigger caused when vehicle 414 drove away.

FIG. 5D illustrates an example of a video frame 508 that may be captured by one or more of cameras 402 from environment 400 as illustrated in FIG. 4D. Video frame 508 can include plant 406, garbage can 408 (no longer blocked), tree 410, tree 412, and package 418.

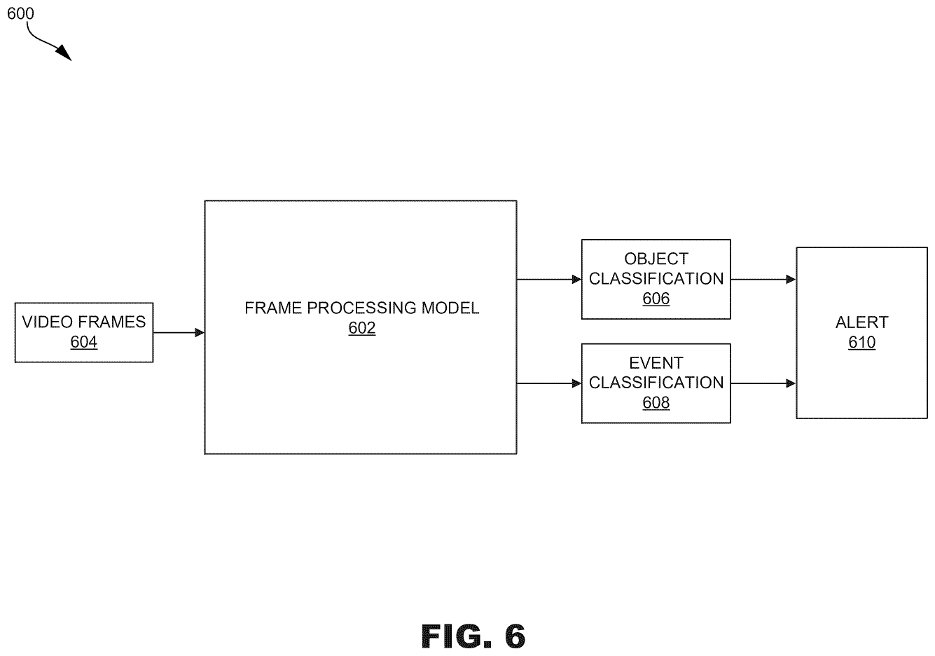

FIG. 6 illustrates an example system 600 for performing event classification and/or object classification. In some aspects, system 600 can include a frame processing model 602. In some examples, frame processing model 602 may be implemented by one or more electronic devices (e.g., camera 402a, camera 402b, camera 402c, user device 307, system servers 305, etc.). In some configurations, frame processing model 602 can be configured to implement one or more algorithms, functions, and/or machine learning models for analyzing and processing video frames 604.

In some aspects, video frames 604 may include one or more frames taken from a sequence of frames captured by an image sensor (e.g., cameras 402). In some cases, the video frames 604 may be selected or extracted from a video recording periodically (e.g., based on a set frequency or interval). In some examples, the video frames 604 may be selected or extracted from a video recording asynchronously or adaptively.

In some aspects, video frames 604 may include video frames captured prior to a trigger event and/or after a trigger event. For instance, video frames 604 may include video frame 502 (e.g., captured prior to trigger from vehicle 414) and video frame 508 (e.g., captured after the motion event concluded). In some cases, frame processing model 602 can compare multiple video frames 604 using one or more algorithms that can identify differences between frames (e.g., algorithm that can yield an XOR output). For example, frame processing model 602 can use a background subtraction algorithm to compare video frame 604. In another example, frame processing model 602 can use an overlap technique such as Intersection Over Union (IoU) to compare video frames 604.

In one illustrative example, frame processing model 602 can perform a comparison of video frame 502 and video frame 508 to identify the difference among the video frames (e.g., package 418). In some aspects, frame processing model 602 can process image data corresponding to package 418 to yield object classification 606 (e.g., label the object as a package).

In some aspects, frame processing model 602 can generate a dense representation of video frames 604 (e.g., a pre-image and a post-image such as video frame 502 and video frame 508). That is, frame processing model 602 can associate one or more pixels in a video frame with one or more labels (e.g., create regions that cover portions of the video frame). In some cases, the dense representation can be used to detect a gross difference, which can trigger a comparison among video frames 604.

In some examples, frame processing model 602 may categorize regions within video frames 604 (e.g., frame processing model 602 can segment and label one or more portions of video frames 604). For instance, a video frame that includes the front portion of a home may include labels for areas corresponding to the porch, the driveway, the lawn, the street, a tree, etc. In some aspects, frame processing model 602 can process video frames based on categorized regions. For example, frame processing model can search for objects that correspond to packages in the region that is categorized as the porch and may disregard searching for packages in the region that is categorized as a tree.

In some cases, frame processing model 602 can determine and encode information associated with an instance of an object within video frames 604. In some aspects, the information can include but is not limited to a description of the object; a latent representation of the object (e.g., feature embedding vectors); an absolute position of the object; a relative position of the object; etc. For example, frame processing model 602 can generate a textual description of an object location and pose (e.g., package 418 is adjacent to plant 406 in video frame 508; garbage can 408 is behind vehicle 414 in video frame 504 and video frame 506; etc.).

In some aspects, frame processing model 602 can be trained to process a sequence of video frames 604 to identify an event (e.g., event classification 608). As noted above, event classification 608 can include any type of event such as an ingress event, an egress event, delivery event, weather event, unclassified object event (e.g., unclassified object appearing, moving, disappearing), any other type of event and/or any combination thereof). In one illustrative example, a long short-term memory (LSTM) can be used to reconstruct an event based on video frames 604. That is, frame processing model 602 can be trained to generalize an event in the temporal space. In some configurations, frame processing model 602 may include additional machine learning models (e.g., sequence-based models such as a transformer). In some cases, the sequence-based models can be used to focus on a particular region of video frames 604 to determine changes associated with detected motion.

In some examples, object classification 606 and/or event classification 608 can be used to generate one or more alerts or notifications (e.g., alert 610). For instance, a user may configure cameras 402 to generate alert 610 upon detection of a package delivery event (e.g., event classification 608). In another example, a user may configure cameras 402 to generate alert 610 upon identification of a package that is located on the front porch (e.g., object classification 606).

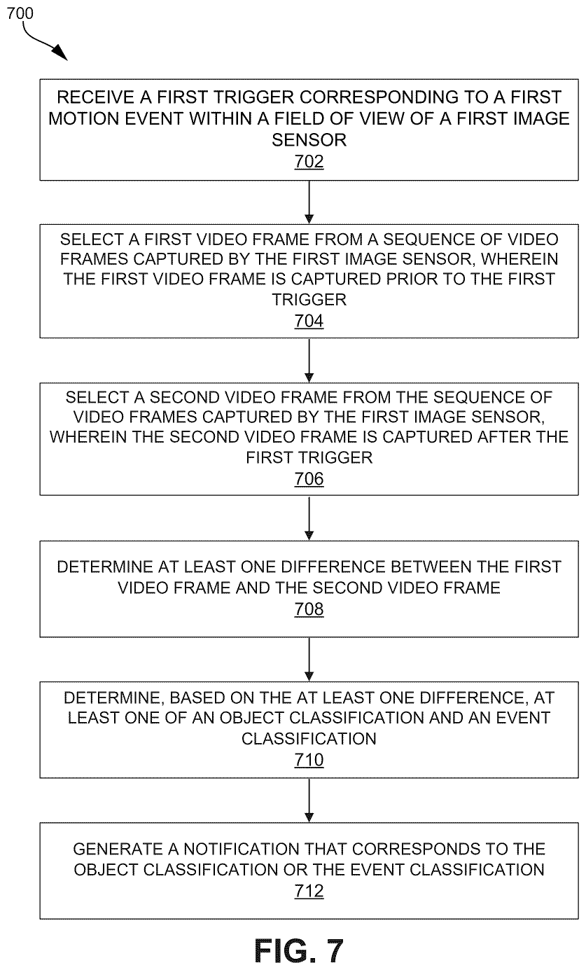

FIG. 7 is a flowchart for a method 700 for performing event classification and/or object classification. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIGS. 4A-4D and 5A-5D. However, method 700 is not limited to that example.

In step 702, the method 700 includes receiving a first trigger corresponding to a first motion event within a field of view of a first image sensor. For example, camera 402b can receive a trigger corresponding to a motion event caused by vehicle 414.

In step 704, the method 700 includes selecting a first video frame from a sequence of video frames captured by the first image sensor, wherein the first video frame is captured prior to the first trigger. For instance, camera 402b can select video frame 502, which is captured prior to the motion trigger caused by vehicle 414.

In step 706, the method 700 includes selecting a second video frame from the sequence of video frames captured by the first image sensor, wherein the second video frame is captured after the first trigger. For example, camera 402b can select video frame 508, which is captured after the motion trigger caused by vehicle 414.

In step 708, the method 700 includes determining at least one difference between the first video frame and the second video frame. For instance, camera 402b can compare video frame 502 with video frame 508 and determine that there is a new object (i.e., package 418) that is located adjacent to plant 406.

In some aspects, to determine the at least one difference between the first video frame and the second video frame, the method 700 includes categorizing a set of regions within the first video frame and the second video frame; and comparing at least one region from the set of regions within the first video frame with a corresponding region from the set of regions within the second video frame. For example, camera 402b can categorize the region adjacent to plant 406 within video frame 502 and video frame 508 as a porch area. In some aspects, camera 402b can compare data from within the porch region in video frame 502 with data from within the porch region in video frame 508 to identify package 418.

In some aspects, to determine the at least one difference between the first video frame and the second video frame, the method 700 includes generating a first representation of the first video frame and a second representation of the second video frame, wherein the first representation and the second representation each include one or more region labels; and comparing the first representation with the second representation to determine the at least one difference. For example, camera 402b can generate a dense representation of video frame 502 and a dense representation of video frame 508 in which each pixel within the corresponding video frame is assigned to a label. In some cases, a gross difference (e.g., greater than a threshold value) among regions of the dense representations can be used to identify a difference among video frames.

In some aspects, to determine the at least one difference between the first video frame and the second video frame, the method 700 includes performing a background subtraction between the first video frame and the second video frame. For instance, camera 402b can implement a background subtraction algorithm to determine the difference between video frame 502 and video frame 508.

In step 710, the method 700 includes determining, based on the at least one difference, at least one of an object classification and an event classification. For example, camera 402b can determine that the new object corresponds to package 418 (e.g., object classification). In another example, camera 402b can determine that the event corresponds to a package delivery (e.g., event classification).

In step 712, the method 700 includes generating a notification that corresponds to the object classification or the event classification. For example, camera 402b can generate a notification associated with package 418. In some cases, the notification can be sent to a user device (e.g., user device 307). In some cases, the object classification can correspond to at least one of a new object, a deleted object, and a moved object and the event classification can correspond to at least one of a delivery event, an egress event, an ingress event, and a trespass event.

In some examples, the method 700 can include determining an end time for the first motion event, wherein the second video frame is captured after the end time. For example, camera 402b can determine an end time for the motion event associated with the delivery of package 418. In some cases, the end time can be determined after detection motion of vehicle 414 leaving the premises.

In some aspects, the method 700 can include sending the notification of the event classification to one or more image sensors that are associated with the first image sensor. For example, camera 402b can send the notification of the event classification to camera 402a and/or camera 402c. In some aspects, event classification can correspond to an intermediate state of an event that is determined by an image sensor. For instance, camera 402b can determine that a package delivery event is taking place and that person 416 should be visible by camera 402a when returning to vehicle 414. In some aspects, camera 402a can receive the state (e.g., event notification from camera 402b) and classify the event (e.g., package delivery) upon completion.

In some cases, camera 402a and/or camera 402c may detect an anomaly if an expected action does not occur. For example, an anomaly can be detected if person 416 walks in the opposite direction and enters the field of view of camera 402c instead of returning to vehicle 4124. In some instances, an anomaly detection can trigger an alert (e.g., alert 610) to inform a user that a deviation has occurred (e.g., package delivery event is different than others).

In some examples, the method 700 can include determining that the at least one difference between the first video frame and the second video frame corresponds to a difference in ambient lighting that exceeds a maximum threshold. For instance, video frame 502 may be captured at night with camera night mode enabled and video frame 506 may be captured at night with night mode disabled because motion-activated lighting turned on. In some aspects, the method 900 can include selecting a third video frame from the sequence of video frames captured by the first image sensor and comparing at least one of the first video frame and the second video frame to the third video frame to identify one or more differences. For example, video frame 508 can be compared to video frame 502 and/or video frame 506 to determine if the difference in lighting conditions is gone. For instance, the motion activated lighting may have turned off by the time video frame 506 was captured (e.g., night mode enabled on camera), and the ambient lighting conditions can be the same or similar among video frame 502 and video frame 508.

In some instances, the method 700 can include receiving a second trigger corresponding to a second motion event within the field of view of the first image sensor; selecting a third video frame from the sequence of video frames captured by the first image sensor, wherein the third video frame is captured after the second trigger; determining a change between the second video frame and the third video frame; and determining whether the change is present between the first video frame and the third video frame. For example, a second trigger can correspond to a motion event caused by person 416 walking out of vehicle 414. In some aspects, camera 402b can select video frame 506 (e.g., captured after the second trigger) and determine a change between video frame 508 and video frame 506. That is, camera 402b can determine that garbage can 408 appeared in video frame 508. In some cases, camera 402b can then compare video frame 508 with video frame 502 to determine whether the change is also present there. In this example, the trash can is present in both video frames (e.g., video frame 502 and video frame 508) therefore camera 402b can chose to ignore this event. That is, garbage can 408 is not new to the scene but was merely obscured by vehicle 414.

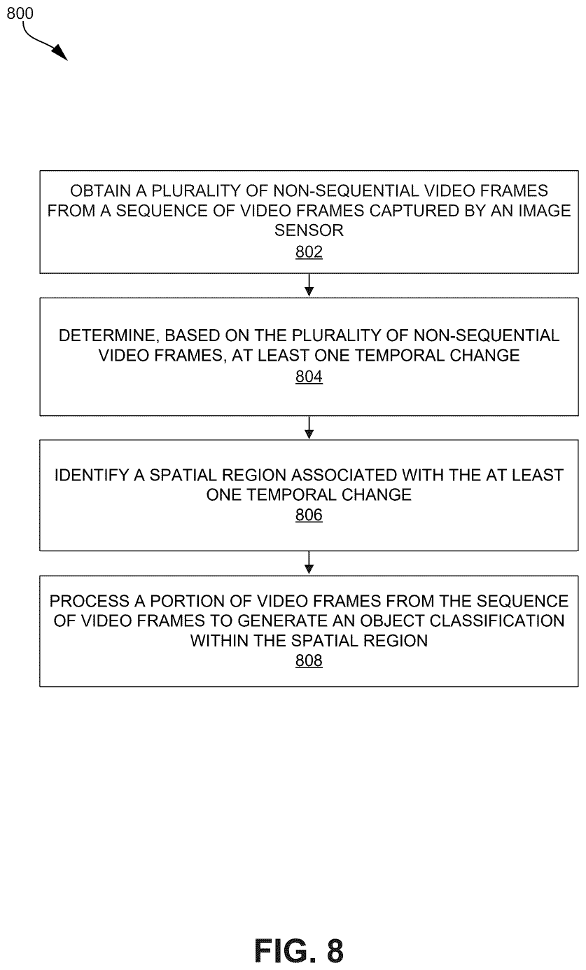

FIG. 8 is a flowchart for a method 800 for performing event classification and/or object classification. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIG. 6. However, method 800 is not limited to that example.

In step 802, the method 800 includes obtaining a plurality of non-sequential video frames from a sequence of video frames captured by an image sensor. For example, frame processing model 602 can obtain video frames 604, which can correspond to non-sequential video frames captured by an image sensor (e.g., cameras 402).

In step 804, the method 800 includes determining, based on the plurality of non-sequential video frames, at least one temporal change. For instance, frame processing model 602 can determine a temporal change among two or more of the video frames 604. For instance, frame processing model 602 can determine a temporal change between video frame 502 and video frame 508.

In step 806, the method 800 includes identifying a spatial region associated with the at least one temporal change. For example, frame processing model 602 can identify a spatial region adjacent to plant 406 that is associated with the temporal change.

In step 808, the method 800 includes processing a portion of video frames from the sequence of video frames to generate an object classification within the spatial region. For instance, frame processing model 602 can process video frame 506 and video frame 508 to generate object classification 606 (e.g., identify package 418).

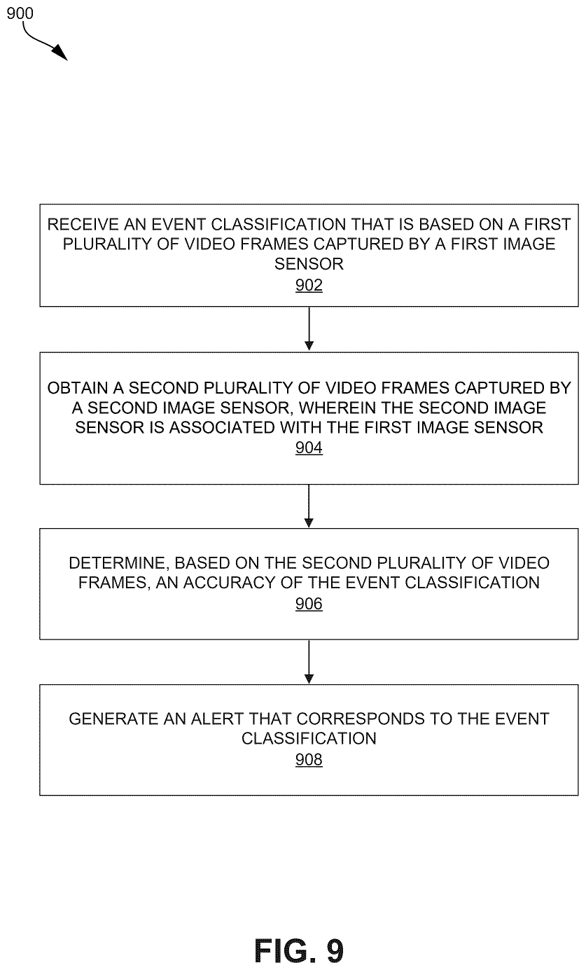

FIG. 9 is a flowchart for a method 900 for performing event classification and/or object classification. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art.

Method 900 shall be described with reference to FIGS. 4A-4D and 5A-5D. However, method 900 is not limited to that example.

In step 902, the method 900 includes receiving an event classification that is based on a first plurality of video frames captured by a first image sensor. For example, camera 402b can receive an event classification from camera 402a that is based on video frames captured by camera 402a. For instance, camera 402a may capture video frame 504 and classify the event as a delivery event based on the presence of vehicle 414. Based on this event classification received from camera 402a, camera 402b would expect to capture video of a delivery person coming to an area near the door of house 404.

In step 904, the method 900 includes obtaining a second plurality of video frames captured by a second image sensor, wherein the second image sensor is associated with the first image sensor. For instance, camera 402b can obtain video frame 506 that includes person 416 carrying package 418. In another example that is not illustrated, camera 402b may detect an anomaly if person 416 does not come into view (e.g., person 416 trespasses and goes into the backyard).

In step 906, the method 900 includes determining, based on the second plurality of video frames, an accuracy of the event classification. For example, camera 402b can determine an accuracy of the event classification (e.g., package delivery) based on video frame 506 and/or video frame 508.

In step 908, the method 900 includes generating an alert that corresponds to the event classification. For instance, camera 402b can send an alert corresponding to the event classification to one or more other electronic devices. In some cases, camera 402b may send an alert to a user device (e.g., indicating package delivery event or an anomaly detection).

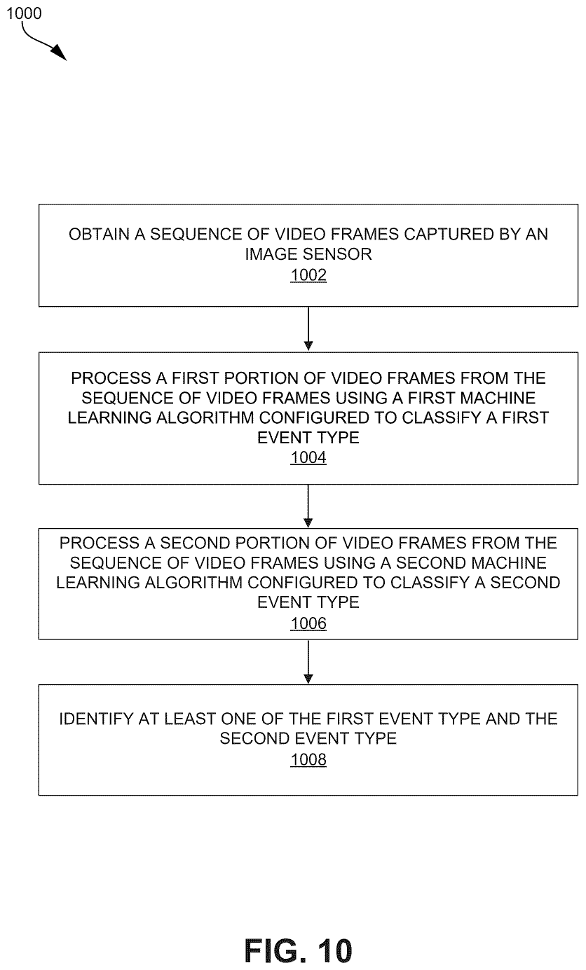

FIG. 10 is a flowchart for a method 1000 for performing event classification and/or object classification. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art.

Method 1000 shall be described with reference to FIG. 6. However, method 1000 is not limited to that example.

In step 1002, the method 1000 includes obtaining a sequence of video frames captured by an image sensor. For example, frame processing model 602 can obtain video frames 604 (e.g., captured by cameras 402).

In step 1004, the method 1000 includes processing a first portion of video frames from the sequence of video frames using a first machine learning algorithm configured to classify a first event type. For example, frame processing model 602 may include a first machine learning model that is trained to process video frames 604 in order to classify package delivery events.

In step 1006, the method 1000 includes processing a second portion of video frames from the sequence of video frames using a second machine learning algorithm configured to classify a second even type. For instance, frame processing model 602 may include a second machine learning model that is trained to process video frames 604 in order to classify a trespass event. That is, the first machine learning model and the second machine learning model can use video frames extracted from the same video recording to classify disparate events.

In step 1008, the method 1000 includes identifying at least one of the first event type and the second event type. For example, frame processing model 602 may identify at least one of a package delivery event or a trespass event (e.g., event classification 608) based on video frames 604.

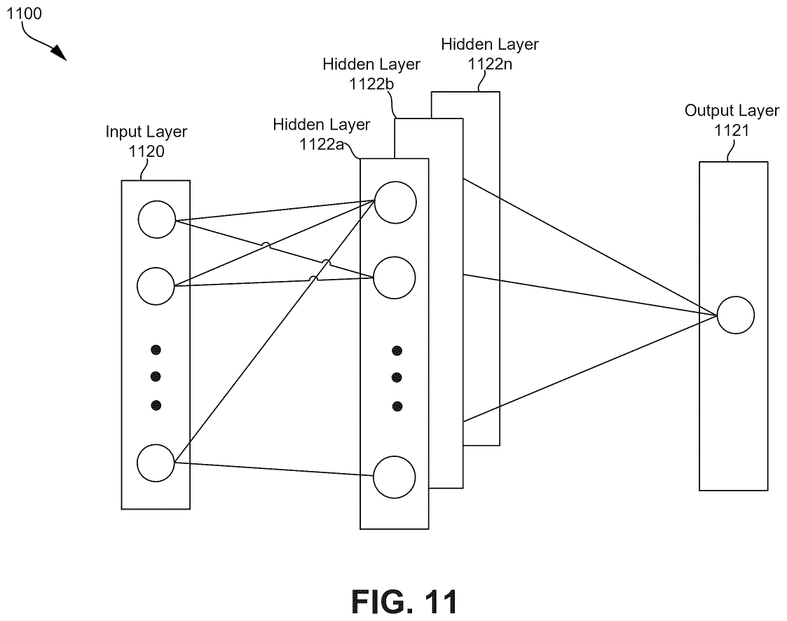

FIG. 11 is a diagram illustrating an example of a neural network architecture 1100 that can be used to implement some or all of the neural networks described herein. The neural network architecture 1100 can include an input layer 1120 can be configured to receive and process data to generate one or more outputs. The neural network architecture 1100 also includes hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The neural network architecture 1100 further includes an output layer 1121 that provides an output resulting from the processing performed by the hidden layers 1122a, 1122b, through 1122n.

The neural network architecture 1100 is a multi-layer neural network of interconnected nodes. Each node can represent a piece of information. Information associated with the nodes is shared among the different layers and each layer retains information as information is processed. In some cases, the neural network architecture 1100 can include a feed-forward network, in which case there are no feedback connections where outputs of the network are fed back into itself. In some cases, the neural network architecture 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the first hidden layer 1122a can transform the information of each input node by applying activation functions to the input node information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1121, at which an output is provided. In some cases, while nodes in the neural network architecture 1100 are shown as having multiple output lines, a node can have a single output and all lines shown as being output from a node represent the same output value.

In some cases, each node or interconnection between nodes can have a weight that is a set of parameters derived from the training of the neural network architecture 1100. Once the neural network architecture 1100 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 1100 to be adaptive to inputs and able to learn as more and more data is processed.

The neural network architecture 1100 is pre-trained to process the features from the data in the input layer 1120 using the different hidden layers 1122a, 1122b, through 1122n in order to provide the output through the output layer 1121.

In some cases, the neural network architecture 1100 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 1100 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 1100 can perform a backward pass by determining which inputs (weights) most contributed to the loss of the network, and can adjust the weights so that the loss decreases and is eventually minimized.

The neural network architecture 1100 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 1100 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

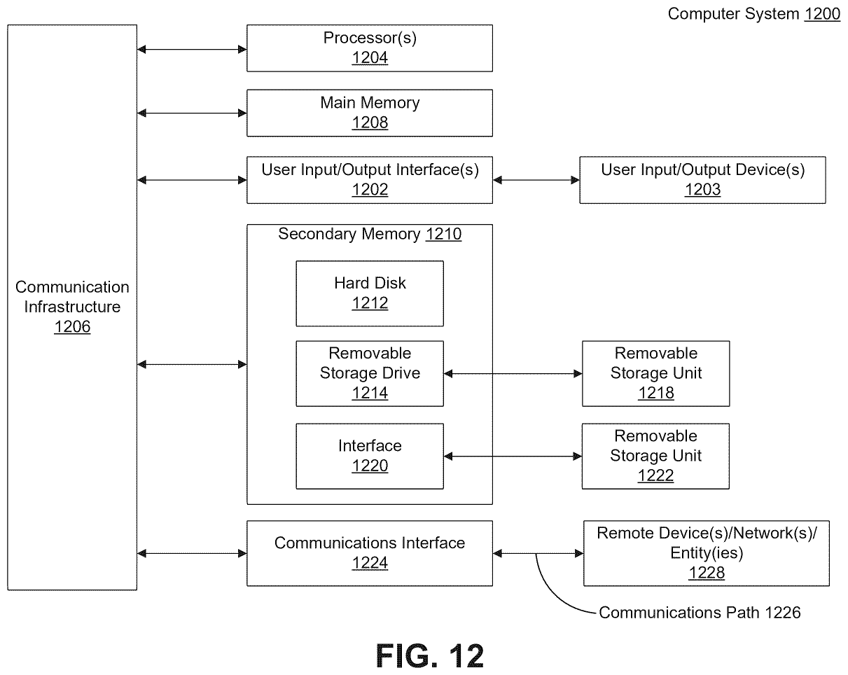

Various aspects and examples may be implemented, for example, using one or more well-known computer systems, such as computer system 1200 shown in FIG. 12. For example, the media device 106 may be implemented using combinations or sub-combinations of computer system 1200. Also or alternatively, one or more computer systems 1200 may be used, for example, to implement any of the aspects and examples discussed herein, as well as combinations and sub-combinations thereof.

Computer system 1200 may include one or more processors (also called central processing units, or CPUs), such as a processor 1204. Processor 1204 may be connected to a communication infrastructure or bus 1206.

Computer system 1200 may also include user input/output device(s) 1203, such as monitors, keyboards, pointing devices, etc., which may communicate with communication infrastructure 1206 through user input/output interface(s) 1202.

One or more of processors 1204 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 may also include a main or primary memory 1208, such as random access memory (RAM). Main memory 1208 may include one or more levels of cache. Main memory 1208 may have stored therein control logic (e.g., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 may include a computer usable or readable storage device having stored thereon computer software (control logic) and/or data. Removable storage unit 1218 may be a floppy disk, magnetic tape, compact disk, DVD, optical storage disk, and/any other computer data storage device. Removable storage drive 1214 may read from and/or write to removable storage unit 1218.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1200 may include a communication or network interface 1224. Communication interface 1224 may enable computer system 1200 to communicate and interact with any combination of external devices, external networks, external entities, etc. (individually and collectively referenced by reference number 1228). For example, communication interface 1224 may allow computer system xx00 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200 or processor(s) 1204), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 12. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A system comprising: one or more memories; and at least one processor coupled to at least one of the one or more memories and configured to perform operations comprising: receive a first trigger corresponding to a first motion event within a field of view of a first image sensor; select a first video frame from a sequence of video frames captured by the first image sensor, wherein the first video frame is captured prior to the first trigger; select a second video frame from the sequence of video frames captured by the first image sensor, wherein the second video frame is captured after the first trigger; determine at least one difference between the first video frame and the second video frame; determine, based on the at least one difference, at least one of an object classification and an event classification; and generate a notification that corresponds to the object classification or the event classification.
Aspect 2. The system of Aspect 1, wherein the at least one processor is configured to perform operations comprising: determine an end time for the first motion event, wherein the second video frame is captured after the end time.
Aspect 3. The system of any of Aspects 1 to 2, wherein the at least one processor is configured to perform operations comprising: receive a second trigger corresponding to a second motion event within the field of view of the first image sensor; select a third video frame from the sequence of video frames captured by the first image sensor, wherein the third video frame is captured after the second trigger; determine a change between the second video frame and the third video frame; and determine whether the change is present between the first video frame and the third video frame.
Aspect 4. The system of any of Aspects 1 to 3, wherein to determine the at least one difference between the first video frame and the second video frame the at least one processor is configured to perform operations comprising: categorize a set of regions within the first video frame and the second video frame; and compare at least one region from the set of regions within the first video frame with a corresponding region from the set of regions within the second video frame.
Aspect 5. The system of any of Aspects 1 to 4, wherein to determine the at least one difference between the first video frame and the second video frame the at least one processor is configured to perform operations comprising: generate a first representation of the first video frame and a second representation of the second video frame, wherein the first representation and the second representation each include one or more region labels; and compare the first representation with the second representation to determine the at least one difference.
Aspect 6. The system of any of Aspects 1 to 5, wherein to determine the at least one difference between the first video frame and the second video frame the at least one processor is configured to perform operations comprising: perform a background subtraction between the first video frame and the second video frame.
Aspect 7. The system of any of Aspects 1 to 6, wherein the at least one processor is configured to perform operations comprising: determine that the at least one difference between the first video frame and the second video frame corresponds to a difference in ambient lighting that exceeds a maximum threshold; in response to determining that the difference in ambient lighting exceeds the maximum threshold, select a third video frame from the sequence of video frames captured by the first image sensor; and compare at least one of the first video frame and the second video frame to the third video frame to identify one or more differences.
Aspect 8. The system of any of Aspects 1 to 7, wherein the at least one processor is configured to perform operations comprising: send the notification of the event classification to one or more image sensors that are associated with the first image sensor.
Aspect 9. The system of any of Aspects 1 to 8, wherein the object classification corresponds to at least one of a new object, a deleted object, and a moved object.
Aspect 10. The system of any of Aspects 1 to 9, wherein the event classification corresponds to at least one of a delivery event, an egress event, an ingress event, and a trespass event.
Aspect 11. A computer-implemented method comprising: receiving a first trigger corresponding to a first motion event within a field of view of a first image sensor; selecting a first video frame from a sequence of video frames captured by the first image sensor, wherein the first video frame is captured prior to the first trigger; selecting a second video frame from the sequence of video frames captured by the first image sensor, wherein the second video frame is captured after the first trigger; determining at least one difference between the first video frame and the second video frame; determining, based on the at least one difference, at least one of an object classification and an event classification; and generating a notification that corresponds to the object classification or the event classification.
Aspect 12. The computer-implemented method of Aspect 11, further comprising: determining an end time for the first motion event, wherein the second video frame is captured after the end time.
Aspect 13. The computer-implemented method of any of Aspects 11 to 12, further comprising: receiving a second trigger corresponding to a second motion event within the field of view of the first image sensor; selecting a third video frame from the sequence of video frames captured by the first image sensor, wherein the third video frame is captured after the second trigger; determining a change between the second video frame and the third video frame; and determining whether the change is present between the first video frame and the third video frame.
Aspect 14. The computer-implemented method of any of Aspects 11 to 13, wherein determining the at least one difference between the first video frame and the second video frame further comprises: categorizing a set of regions within the first video frame and the second video frame; and comparing at least one region from the set of regions within the first video frame with a corresponding region from the set of regions within the second video frame.
Aspect 15. The computer-implemented method of any of Aspects 11 to 14, wherein determining the at least one difference between the first video frame and the second video frame further comprises: generating a first representation of the first video frame and a second representation of the second video frame, wherein the first representation and the second representation each include one or more region labels; and comparing the first representation with the second representation to determine the at least one difference.
Aspect 16. The computer-implemented method of any of Aspects 11 to 15, wherein determining the at least one difference between the first video frame and the second video frame further comprises: performing a background subtraction between the first video frame and the second video frame.
Aspect 17. The computer-implemented method of any of Aspects 11 to 16, further comprising: determining that the at least one difference between the first video frame and the second video frame corresponds to a difference in ambient lighting that exceeds a maximum threshold; in response to determining that the difference in ambient lighting exceeds the maximum threshold, selecting a third video frame from the sequence of video frames captured by the first image sensor; and comparing at least one of the first video frame and the second video frame to the third video frame to identify one or more differences.
Aspect 18. The computer-implemented method of any of Aspects 11 to 17, further comprising: sending the notification of the event classification to one or more image sensors that are associated with the first image sensor.
Aspect 19. The computer-implemented method of any of Aspects 11 to 18, wherein the object classification corresponds to at least one of a new object, a deleted object, and a moved object and wherein the event classification corresponds to at least one of a delivery event, an egress event, an ingress event, and a trespass event.
Aspect 20. A non-transitory computer-readable medium having instructions stored thereon that, when executed by at least one computing device, cause the at least one computing device to perform a method according to any of Aspects 11 to 19.
Aspect 21. A system comprising means for performing a method according to any of Aspects 11 to 19.

What is claimed is:

1. A system comprising:
one or more memories; and
at least one processor coupled to at least one of the one or more memories and configured to perform operations comprising:
receive a first trigger corresponding to a first motion event within a field of view of a first image sensor;
select a first video frame from a sequence of video frames captured by the first image sensor, wherein the first video frame is captured prior to the first trigger;
select a second video frame from the sequence of video frames captured by the first image sensor, wherein the second video frame is captured after the first trigger;
determine at least one difference between the first video frame and the second video frame;
determine, based on the at least one difference, at least one of an object classification and an event classification; and
generate a notification that corresponds to the object classification or the event classification.

2. The system of claim 1, wherein the at least one processor is configured to perform operations comprising:
determine an end time for the first motion event, wherein the second video frame is captured after the end time.

3. The system of claim 1, wherein the at least one processor is configured to perform operations comprising:
receive a second trigger corresponding to a second motion event within the field of view of the first image sensor;
select a third video frame from the sequence of video frames captured by the first image sensor, wherein the third video frame is captured after the second trigger;
determine a change between the second video frame and the third video frame; and
determine whether the change is present between the first video frame and the third video frame.

4. The system of claim 1, wherein to determine the at least one difference between the first video frame and the second video frame the at least one processor is configured to perform operations comprising:
categorize a set of regions within the first video frame and the second video frame; and
compare at least one region from the set of regions within the first video frame with a corresponding region from the set of regions within the second video frame.

5. The system of claim 1, wherein to determine the at least one difference between the first video frame and the second video frame the at least one processor is configured to perform operations comprising:
generate a first representation of the first video frame and a second representation of the second video frame, wherein the first representation and the second representation each include one or more region labels; and
compare the first representation with the second representation to determine the at least one difference.

6. The system of claim 1, wherein to determine the at least one difference between the first video frame and the second video frame the at least one processor is configured to perform operations comprising:
perform a background subtraction between the first video frame and the second video frame.

7. The system of claim 1, wherein the at least one processor is configured to perform operations comprising:
determine that the at least one difference between the first video frame and the second video frame corresponds to a difference in ambient lighting that exceeds a maximum threshold;
in response to determining that the difference in ambient lighting exceeds the maximum threshold, select a third video frame from the sequence of video frames captured by the first image sensor; and
compare at least one of the first video frame and the second video frame to the third video frame to identify one or more differences.

8. The system of claim 1, wherein the at least one processor is configured to perform operations comprising:
send the notification of the event classification to one or more image sensors that are associated with the first image sensor.

9. The system of claim 1, wherein the object classification corresponds to at least one of a new object, a deleted object, and a moved object.

10. The system of claim 1, wherein the event classification corresponds to at least one of a delivery event, an egress event, an ingress event, and a trespass event.

11. A computer-implemented method comprising:
receiving a first trigger corresponding to a first motion event within a field of view of a first image sensor;
selecting a first video frame from a sequence of video frames captured by the first image sensor, wherein the first video frame is captured prior to the first trigger;
selecting a second video frame from the sequence of video frames captured by the first image sensor, wherein the second video frame is captured after the first trigger;
determining at least one difference between the first video frame and the second video frame;
determining, based on the at least one difference, at least one of an object classification and an event classification; and
generating a notification that corresponds to the object classification or the event classification.

12. The computer-implemented method of claim 11, further comprising:
determining an end time for the first motion event, wherein the second video frame is captured after the end time.

13. The computer-implemented method of claim 11, further comprising:
receiving a second trigger corresponding to a second motion event within the field of view of the first image sensor;
selecting a third video frame from the sequence of video frames captured by the first image sensor, wherein the third video frame is captured after the second trigger;
determining a change between the second video frame and the third video frame; and
determining whether the change is present between the first video frame and the third video frame.

14. The computer-implemented method of claim 11, wherein determining the at least one difference between the first video frame and the second video frame further comprises:
categorizing a set of regions within the first video frame and the second video frame; and
comparing at least one region from the set of regions within the first video frame with a corresponding region from the set of regions within the second video frame.

15. The computer-implemented method of claim 11, wherein determining the at least one difference between the first video frame and the second video frame further comprises:
generating a first representation of the first video frame and a second representation of the second video frame, wherein the first representation and the second representation each include one or more region labels; and
comparing the first representation with the second representation to determine the at least one difference.

16. The computer-implemented method of claim 11, wherein determining the at least one difference between the first video frame and the second video frame further comprises:
performing a background subtraction between the first video frame and the second video frame.

17. The computer-implemented method of claim 11, further comprising:
determining that the at least one difference between the first video frame and the second video frame corresponds to a difference in ambient lighting that exceeds a maximum threshold;
in response to determining that the difference in ambient lighting exceeds the maximum threshold, selecting a third video frame from the sequence of video frames captured by the first image sensor; and
comparing at least one of the first video frame and the second video frame to the third video frame to identify one or more differences.

18. The computer-implemented method of claim 11, further comprising:
sending the notification of the event classification to one or more image sensors that are associated with the first image sensor.

19. The computer-implemented method of claim 11, wherein the object classification corresponds to at least one of a new object, a deleted object, and a moved object and wherein the event classification corresponds to at least one of a delivery event, an egress event, an ingress event, and a trespass event.

20. A non-transitory computer-readable medium having instructions stored thereon that, when executed by at least one computing device, cause the at least one computing device to perform operations comprising:
receive a first trigger corresponding to a first motion event within a field of view of a first image sensor;
select a first video frame from a sequence of video frames captured by the first image sensor, wherein the first video frame is captured prior to the first trigger;
select a second video frame from the sequence of video frames captured by the first image sensor, wherein the second video frame is captured after the first trigger;
determine at least one difference between the first video frame and the second video frame;
determine, based on the at least one difference, at least one of an object classification and an event classification; and
generate a notification that corresponds to the object classification or the event classification.
